(19) United States
(12) Patent Application Publication
(10) Pub. No.: US 2019/0317976 A1
(43) Pub. Date: Oct. 17, 2019

(54) GEOLOCATION BASED REUSABLE SIGN RIDERS

(71) Applicant: ListReports, Inc., Orange, CA (US)

(72) Inventors: Ajay Vinod Shah, Orange, CA (US); David Duane Elkins, Irvine, CA (US)

(21) Appl. No.: 16/382,978

(22) Filed: Apr. 12, 2019

Related U.S. Application Data
(60) Provisional application No. 62/657,478, filed on Apr. 13, 2018.

(51) Int. Cl. G06F 16/955; G06Q 50/16; G06K 7/14; H04W 4/029

(52) U.S. Cl. CPC G06F 16/9554; H04W 4/029; G06K 7/1417; G06Q 50/16

(57) ABSTRACT

A system and method leveraging the use of sign riders in conjunction with geolocation technology to provide real-time delivery of real estate property information to potential buyers is provided.

### CROSS-REFERENCE TO RELATED APPLICATIONS

The present application claims the benefit of U.S. Provisional Patent Application No. 62/657,478, filed Apr. 13, 2018, the disclosure of which is hereby incorporated by reference herein in its entirety.

### TECHNICAL FIELD

The subject matter disclosed herein relates to use of sign riders to relay information about real estate property, and more specifically, to real-time delivery of real estate property details using geolocation based reusable sign riders.

### BACKGROUND

It is common for sign riders posted on a property to provide a name or phone number of a real estate agent, realtor agency or property owner, allowing potential buyers to acquire more information about the property. This type of communication method may cause potential buyers, who may just want to get a cursory amount of information about a property, to avoid taking action so as to avoid an unwelcome sales pitch about a property that may not necessarily match their interest.

Another method of communication may be providing printed copies of a flyer containing information about a property, which may be placed with a sign rider. Unfortunately, creating and maintaining the availability of flyers is time-consuming, is prone to inclement weather, and may become outdated over time (e.g., change in sale price, property improvements, etc.).

Yet another method of communication may be to provide a sign rider having a code associated with a particular property, where a potential buyer may text the code to a number and receive updated information about the property. Unfortunately, this solution has its shortcomings as well in that there is an inherent cost to creating a sign rider with a separate code for each dedicated property.

Accordingly, there is a need for improved methods of communicating property information to potential buyers.

### BRIEF DESCRIPTION OF THE DRAWINGS

In order to facilitate a fuller understanding of the present disclosure, reference is made to the accompanying drawings, in which like elements are referenced with like numerals. These drawings should not be construed as limiting the present disclosure, but are intended to be exemplary only.

FIG. 1 illustrates an exemplary system architecture in accordance with an embodiment of the present disclosure.

FIGS. 2A and 2B illustrate sign rider environments in accordance with an embodiment of the present disclosure.

FIG. 3 is a flow diagram illustrating a method for providing information relating to property listings in accordance with an embodiment of the present disclosure.

FIG. 4 illustrates a geolocation map in accordance with an embodiment of the present disclosure.

FIG. 5 is a block diagram illustrating an exemplary computer system in accordance with an embodiment of the present disclosure.

### DETAILED DESCRIPTION

Disclosed herein are embodiments for providing real estate information to a potential buyer. More specifically, the embodiments provided herein describe a system and method leveraging the use of sign riders in conjunction with geolocation technology to provide real-time delivery of real estate property information to potential buyers.

In the following description, numerous details are set forth. It will be apparent, however, to one skilled in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed descriptions may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the description that follows, it is appreciated that throughout the description, discussions utilizing terms such as “receiving”, “associating”, “determining”, “requesting”, “identifying”, “generating”, “retrieving”, “transmitting”, “performing”, “processing”, “enabling”, “optimizing”, “detecting”, “modifying”, “storing”, “applying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus, device or system for performing the operations herein. This apparatus, device or system may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions.

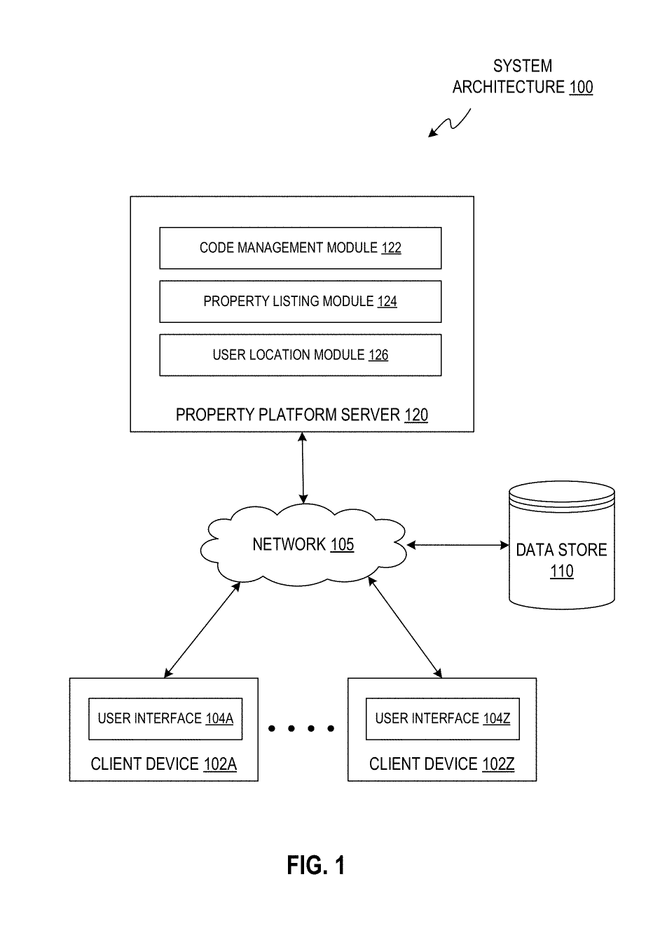

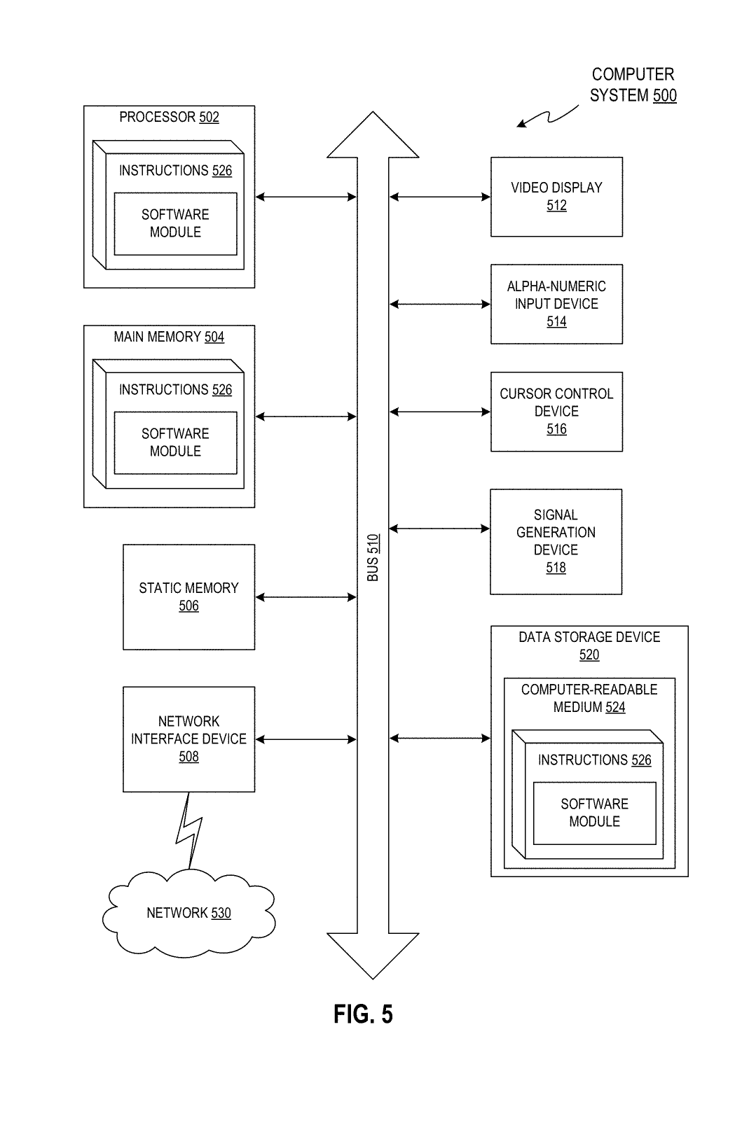

FIG. 1 illustrates an exemplary system architecture 100, in accordance with an embodiment of the present disclosure, for providing real estate information to a potential buyer. The system architecture 100 includes client devices 102A-102Z, a data store 110, and a property platform server 120, wherein each of the foregoing devices are communicatively coupled via a network 105. One or more of the devices of system architecture 100 may be implemented using computer system 500, described below with respect to FIG. 5.

Network 105 may include a public network (e.g., the Internet), a private network (e.g., a local area network (LAN), a wide area network (WAN), or a Bluetooth network), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although network 105 is depicted as a single network, network 105 may include one or more networks operating as stand-alone networks or in cooperation with each other. Network 105 may utilize one or more protocols of one or more devices to which they are communicatively coupled. Network 105 may translate to or from other protocols to one or more protocols of networked devices.

Data store 110 may include one or more of a short-term memory (e.g., random access memory), a cache, a drive (e.g., a hard drive), a flash drive, a database system, or another type of component or device capable of storing data. Data store 110 may also include multiple storage components (e.g., multiple drives or multiple databases) that may also span multiple computing devices (e.g., multiple server computers). In some embodiments, data store 110 may be cloud-based. One or more of the devices of system architecture 100 may utilize their own storage and/or data store 110 to store public and private data, and data store 110 may be configured to provide secure storage for private data. In some embodiments, data store 110 may be used for data back-up or archival purposes.

Client devices 102A-102Z may each include computing devices such as personal computers (PCs), laptops, mobile phones, smart phones, tablet computers, netbook computers, etc. Client devices 102A-102Z may also be referred to as “user devices” or “mobile devices”. An individual user may be associated with (e.g., own and/or use) one or more of client devices 102A-102Z. Client devices 102A-102Z may each be owned and utilized by different users at different locations. As used herein, a “user” may be represented as a single individual. However, other embodiments of the present disclosure encompass a “user” being an entity controlled by a set of users and/or an automated source. For example, a set of individual users federated as a community in a company or government organization may be considered a “user”.

Client devices 102A-102Z may each implement user interfaces 104A-104Z, respectively. Each of user interfaces 104A-104Z may allow a user of respective client device 102A-102Z to send/receive information to/from each other, data store 110, and property platform server 120. For example, one or more of user interfaces 104A-104Z may be a web browser interface that can access, retrieve, present, and/or navigate content (e.g., web pages such as Hyper Text Markup Language (HTML) pages) provided by property platform server 120. As another example, one or more of user interfaces 104A-104Z may be a standalone application (e.g., a mobile “app”, etc.), that allows a user of a respective client device 102A-102Z to send/receive information to/from each other, data store 110, and property platform server 120.

In some embodiments, client devices 102A-102Z may each utilize local data stores in lieu of or in combination with data store 110. Each of the local data stores may be internal or external devices, and may include one or more of a short-term memory (e.g., random access memory), a cache, a drive (e.g., a hard drive), a flash drive, a database system, or another type of component or device capable of storing data. The local data stores may also include multiple storage components (e.g., multiple drives or multiple databases) that may also span multiple computing devices (e.g., multiple server computers). In some embodiments, the local data stores may be used for data back-up or archival purposes.

Property platform server 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to retrieve data related to real estate property.

In one embodiment, property platform server 120 may be comprised of a code management module 122, a property listing module 124 and a user location module 126. Code management module 122 may implement instructions for assigning and maintaining codes associated with real estate entities. For example, code management module 122 may assign a unique code to a real estate agent, where associating the unique code with the real estate agent enables the agent to maintain (i.e., add, remove, edit, etc.) one or more of their property listings. Property listing module 124 may be configured to implement instructions for identifying and retrieving information relating to a real estate property listing. For example, property listing module 124 may retrieve information for a property listing associated with a unique code of a real estate agent. User location module 126 may implement instructions for determining a geolocation of client devices 102A-102Z. For example, user location module 126 may receive GPS position data associated with client devices 102A-102Z to determine the geolocation of potential buyers.

Although each of client devices 102A-102Z, data store 110, and property platform server 120 are depicted in FIG. 1 as single, disparate components, these components may be implemented together in a single device or networked in various combinations of multiple different devices that operate together. For example, in some embodiments, some or all of the functionality of property platform server 120 may be performed by one or more of client devices 102A-102Z.

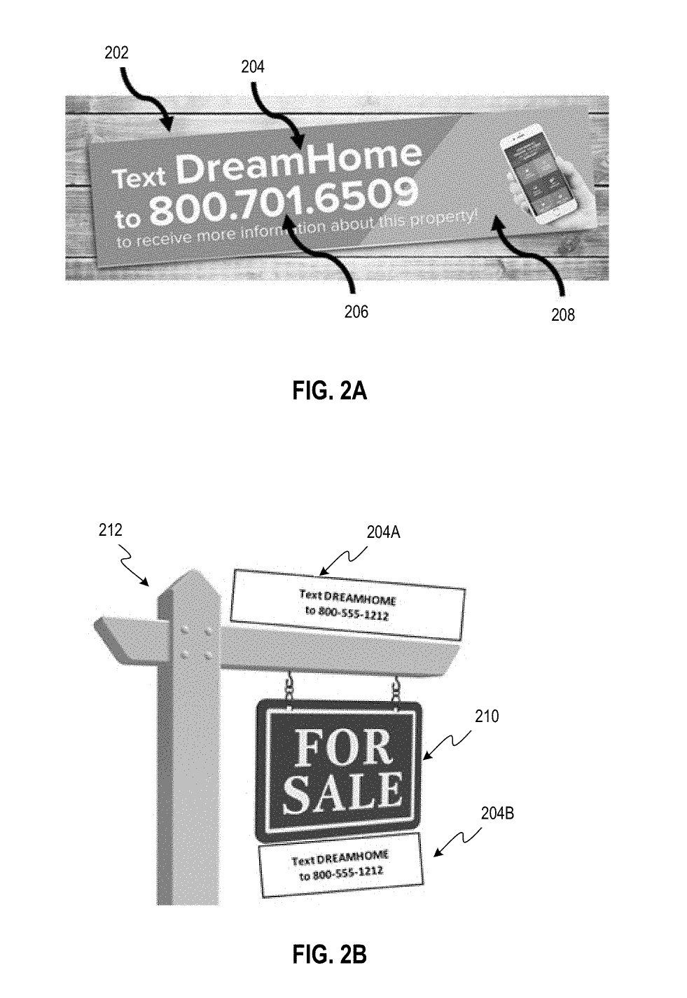

FIGS. 2A and 2B illustrate sign rider environments, in accordance with an embodiment of the present disclosure, for notifying potential buyers of the availability of information relating to real estate properties. Referring to FIG. 2A, a sign rider 202 may be comprised of a code 204, a phone number 206, a message/instruction 208 or various combinations thereof. Referring to FIG. 2B, sign riders 204A/204B may be affixed to a plurality of physical structures. For example, in one embodiment, sign riders 204A/204B may be attached to a portion of a sign 210 (e.g., a “For Sale” sign) or a sign post 212 and placed at a prominent location outside, or in the vicinity, of a real estate property.

In FIGS. 2A and 2B, code 204 is provided as a particular phrase to text. However, one of ordinary skill in the art will appreciate that code 204 may take on the form of any unique code, such as an alphanumeric code (numbers, letters, symbols or a combination thereof), a QR code or any other readably accessible code capable of being transmitted from client devices 102A-102Z. For example, in one embodiment, an alphanumeric-based code 204 may be provided and received by property platform server 120 via a text transmitted from client devices 102A-102Z using phone number 206. In another embodiment, a QR-based code 204 may be provided and received by property platform server 120 when scanned by client devices 102A-102Z.

Code 240 may be associated with a particular agent and their property listings. In one embodiment, the use of sign rider 202 may be coupled to a software service for managing property listings, wherein code 204 may be used by the software service for identifying a particular real estate agent. For example, a real estate agent may request a unique code 204 through the software service where all their property listings may be associated, where receipt of code 204 by the software service triggers a request to retrieve relevant property listing information for the real estate agent. As such, a sign rider 204 bearing the same code 204 may be used at a plurality of locations.

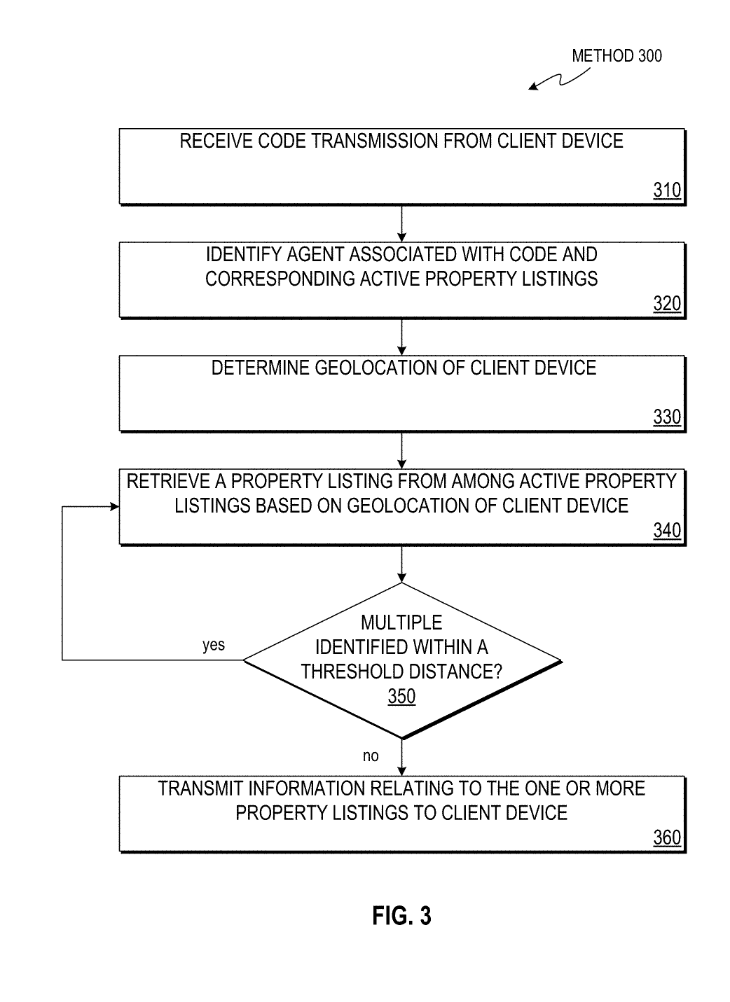

FIG. 3 is a flow diagram illustrating a method 300, in accordance with an embodiment of the present disclosure, for providing information relating to property listings to potential buyers geo-located in the vicinity of one or more relevant properties. Method 300 may be performed by processing logic that includes hardware (e.g., circuitry, dedicated logic, programmable logic, microcode, etc.), software (e.g., instructions run on a processing device to perform hardware simulation), or a combination thereof. In one embodiment, method 300 may be performed by a processing device executing instructions associated with one or more software modules described in FIG. 1. In one embodiment, method 300 is executed by a processing device of a server (e.g., property platform server 120). In another embodiment, method 300 is executed by a processing device of a client device (e.g., one of client devices 102A-102Z). In other embodiments, some of the functionality of the method 300 is distributed between a server and a client device.

For simplicity, the methods of this disclosure are depicted and described as a series of steps. However, steps in accordance with this disclosure can occur in various orders and/or concurrently, and with other steps not presented and described herein. Furthermore, not all illustrated steps may be required to implement the methods in accordance with the disclosed subject matter. Additionally, it should be appreciated that the methods disclosed in this specification are capable of being stored on an article of manufacture to facilitate transporting and transferring such methods to computing devices. The term “article of manufacture”, as used herein, is intended to encompass a computer program accessible from any computer-readable device or storage media.

Referring to FIG. 3, method 300 may be initiated upon receiving, at block 302, a code 204 transmission from one of client devices 102A-102Z. Upon receiving the transmission, an agent associated with code 204 may be identified, at block 320, along with the agent's corresponding active property listings. Active property listings of the agent identified may be retrieved, for example, via property listing module 124 of property platform server 120. Additionally, the geolocation of the client device may be determined, at block 330, at the time of receiving the transmission of code 204. The geolocation of the client device may be determined, for example, via user location module 126 of property platform server 120. Thereafter, at least one property listing may be retrieved, at block 340, from among the agent's active property listings based on the geolocation of the client device determined at block 330.

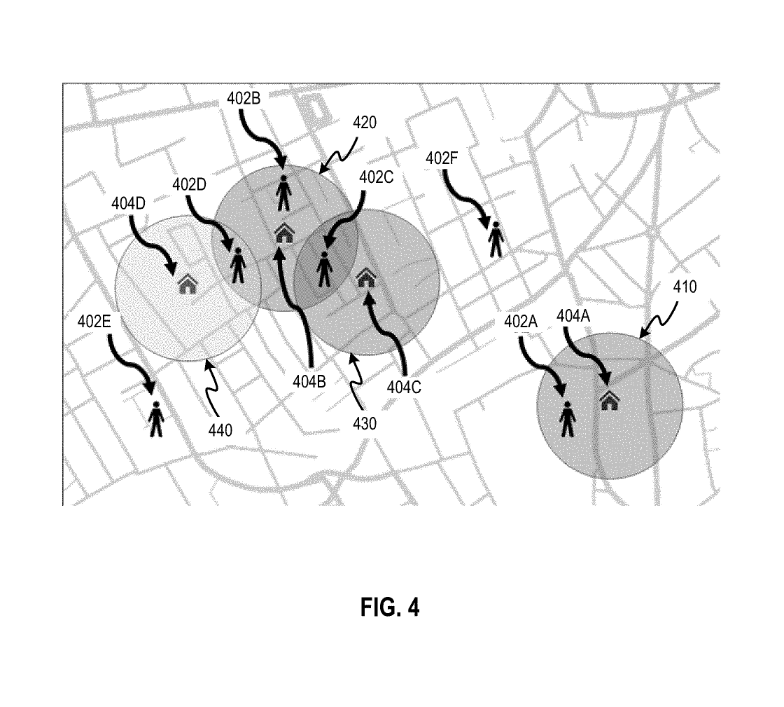

A determination may be made, at block 350, whether multiple property listings have been identified based on the geolocation of the client device. If only one property listing is found in the identified geolocation of the client device, then that property listing is retrieved, at step 340, and information relating to the same is transmitted, at step 360, to the client device. However, a number of instances may exist where multiple property listings are identified within a predetermined threshold distance from the identified geolocation of the client device. By way of example, FIG. 4 illustrates a geolocation map, in accordance with an embodiment of the present disclosure, of potential buyers 402A-402F and active property listings 404A-404D.

In one embodiment, a code 204 may be received from a client device of potential buyer 402A, which is determined to be at a geolocation at or near property listing 404A residing within a geolocation perimeter 410. Similarly, in another embodiment, a code 204 may be received from a client device of potential buyer 402B, which is determined to be at a geolocation at or near property listing 404B residing within a geolocation perimeter 420. In the aforementioned embodiments, no other active property listings associated with code 204 reside within geolocation perimeters 410 or 420. Accordingly, information relating to property listing 404A and 404B are transmitted back, respectively, to client devices of potential buyers 402A and 402B.

In another embodiment, a code 204 may be received from a client device of potential buyer 402C, which is determined to be at a geolocation near property listings 404B and 404C residing, respectively, within geolocation perimeters 420 and 430. In this embodiment, potential buyer 402C may have seen one or both of the properties, but transmitted code 204 at a later time when their geolocation may have changed with respect to both properties. Accordingly, in this instance, information relating to both property listings 404B and 404C may be transmitted back to the client device of potential buyer 402C.

In yet another embodiment, a code 204 may be received from a client device of potential buyer 402D, which is determined to be at a geolocation near property listings 404B and 404D residing, respectively, within geolocation perimeters 420 and 440. However, in this embodiment property, listings 404B and 404D may be associated with different agents, as determined by code 204. Accordingly, in this instance, only information relating to property listing 404D may be transmitted back to the client device of potential buyer 402D.

In yet another embodiment, a code 204 may be received from client devices of potential buyers 402D and 402E, neither of which are determined to be in a geolocation at or near property listings in a geolocation perimeter. In this embodiment, potential buyers 402D and 402E may have seen one or more properties, but transmitted code 204 at a later time when they were well outside a threshold geolocation range. For example, potential buyers 402D and 402E may have transmitted code 204 after returning to their own home. Accordingly, in this instance, information relating to all property listings of an agent associated with code 204 may be transmitted back to client devices of potential buyers 402E and 402F.

FIG. 5 illustrates a diagrammatic representation of a machine in the exemplary form of a computer system 500 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of computer system 500 may be utilized by or illustrative of any of data store 110, one or more of client devices 102A-102Z, and property platform server 120.

The exemplary computer system 500 may be comprised of a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 520, which communicate with each other via a bus 510.

Processor 502 may represent one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute instructions 526 for performing the methodologies and functions discussed herein.

Computer system 500 may further include a network interface device 508. Computer system 500 also may include a video display unit 512 (e.g., a liquid crystal display (LCD), a cathode ray tube (CRT), or a touch screen), an alphanumeric input device 514 (e.g., a keyboard), a cursor control device 516 (e.g., a mouse), and a signal generation device 518 (e.g., a speaker).

Data storage device 520 may include a computer-readable storage medium 524 on which is stored one or more sets of instructions 526 (e.g., software) embodying any one or more of the methodologies or functions described herein. Instructions 526 may also reside, completely or at least partially, within main memory 504 and/or within processor 502 during execution thereof by computer system 500, main memory 504 and processor 502 also constituting computer-readable storage media. Instructions 526 may further be transmitted or received over a network 530 (e.g., network 105) via network interface device 508. In one embodiment, instructions 526 may include instructions for one or more software modules for implementing one or more of the methodologies or functions described herein.

While computer-readable storage medium 524 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The present disclosure is not to be limited in scope by the specific embodiments described herein. Indeed, other various embodiments of and modifications to the present disclosure, in addition to those described herein, will be apparent to those of ordinary skill in the art from the preceding description and accompanying drawings. Thus, such other embodiments and modifications are intended to fall within the scope of the present disclosure. Further, although the present disclosure has been described herein in the context of a particular embodiment in a particular environment for a particular purpose, those of ordinary skill in the art will recognize that its usefulness is not limited thereto and that the present disclosure may be beneficially implemented in any number of environments for any number of purposes.

What is claimed is:

1. A method comprising:
receiving a code at a server, said code transmitted from a client device;
identifying active properties associated with said code;
determining a geolocation of said client device;
retrieving a property listing from said active properties, said property listing retrieved based at least in part on said geolocation of said client device; and
transmitting information relating to said property listing to said client device.

2. The method of claim 1, wherein said code is an alphanumeric code displayed on a sign rider affixed to a physical structure.

3. The method of claim 2, wherein a phone number is displayed with said alphanumeric code on said sign rider, and wherein said alphanumeric code is received by said server via a text message transmitted from said client device using said phone number.

4. The method of claim 1, wherein said code is a QR code displayed on a sign rider affixed to a physical structure.

5. The method of claim 4, wherein said QR code is received by said server via a QR code scanner on said client device.

6. The method of claim 1, further comprising associating said code with an agent.

7. The method of claim 6, wherein said code identifies all active properties for said agent.

8. The method of claim 1, wherein said geolocation of said client device is determined using location data shared by said client device.

9. The method of claim 1, wherein said geolocation of said client device is determined using location data received from a global positioning system.

10. The method of claim 1, further comprising identifying a geolocation perimeter based on said geolocation of said client device.

11. The method of claim 10, wherein active properties are identified in said geolocation perimeter.

12. The method of claim 1, wherein information relating to said property listing is displayed on said client device.

13. A system, comprising:
a memory; and
a processing device communicatively coupled to said memory, said processing device configured to:
receive a code, said code transmitted from a client device;
identify active properties associated with said code;
determine a geolocation of said client device;
retrieve a property listing from said active properties, said property listing retrieved based at least in part on said geolocation of said client device; and
transmit information relating to said property listing to said client device.

14. A non-transitory computer-readable storage medium having instructions encoded thereon that, when executed by a processing device, cause said processing device to perform a method, said method comprising:
receiving a code, said code transmitted from a client device;
identifying active properties associated with said code;
determining a geolocation of said client device;
retrieving a property listing from said active properties, said property listing retrieved based at least in part on said geolocation of said client device; and
transmitting information relating to said property listing to said client device.
